(19) United States
(12) Patent Application Publication
(10) Pub. No.: US 2007/0132671 A1
(43) Pub. Date: Jun. 14, 2007

(54) Plasma display apparatus

(75) Inventor: Jeong Pil Choi, Suwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/636,620

(22) Filed: Dec. 11, 2006

(30) Foreign Application Priority Data
Dec. 12, 2005 (KR) 10-2005-0122192

(51) Int. Cl. G09G 3/28

(52) U.S. Cl. 345/68

(57) ABSTRACT

Disclosed is a plasma display apparatus. The plasma display apparatus includes a plasma display panel comprising scan electrodes, and a scan driver comprising a set up pulse supplier forming a current loop connecting a resistor and capacitors of the plasma display panel to the scan electrodes to thereby supply set up pulses to the scan electrodes.

This Nonprovisional application claims priority under 35 U.S.C. §119(a) on Patent Application No. 10-2005-0122192 filed in Korea on Dec. 12, 2005, the entire contents of which are hereby incorporated by reference.

### BACKGROUND

1. Field

This document relates to a plasma display apparatus.

2. Description of the Background Art

A plasma display panel excites phosphors to emit light using ultraviolet rays generated during discharging an inert mixture gas, such as He+Xe, Ne+Xe, and He+Xe+Ne, in order to display images. This plasma display panel is easy to make thinner and larger, as well as provides an enhanced image quality with recent technological development.

FIG. 1 is a view showing a subfield pattern of 8 bit default code for implementing 256 gray scale in a PDP.

Referring to FIG. 1, a plasma display panel is driven in a time-division manner, with one frame divided into various subfields, each of which has different number of emission to implement gray scale of an image. Each subfield is separated into a reset period for initializing the entire screen, an address period for selecting scan lines and selecting discharge cells from the selected scan lines, and a sustain period for implementing gray scale according to the number of discharges.

For example, a frame section (16.67 ms) corresponding to 1/60 sec is divided into 8 subfields SF1 to SF8 to display an image with 256 gray scale. Each of these 8 subfields SF1 to SF8 is separated into an reset period, an address period, and a sustain period. Whereas a reset period and an address period of each subfield are the same with respect to each subfield, a sustain period and the number of sustain pulses assigned to the sustain period increase at the rate of 2ⁿ(where n=0, 1, 2, 3, 4, 5, 6, 7) with respect to each subfield.

FIG. 2 is a view illustrating driving waveforms of a related art plasma display panel.

Referring to FIG. 2, each subfield SF comprises a reset period RP for initializing discharge cells on the entire screen, an address period AP for selecting discharge cells, and a sustain period SP for sustaining discharge of the selected discharge cells.

A rising ramp-type set up pulses PR is simultaneously applied to all the scan electrodes Y at the set up period of the reset period. This set up pulse PR leads to a weak discharge(set up discharge) in the cells of the entire screen, which causes wall charges to accumulate in the cells.

A falling ramp-type set down pulse NR, which falls by a prescribed slope from a positive sustain voltage Vs having a lower voltage than a peak voltage of the set up pulse PR to a negative voltage, is simultaneously applied to the scan electrodes Y at the set down period SD after the set up pulse PR was applied. The set down pulse NR causes a weak erase discharge in the cells to thereby erase unwanted charges among the wall charges and space charges generated by the set up discharge, which enables the wall charges required for an address discharge to be dispersed evenly in the cells of the entire screen.

A negative scan pulse SCNP is sequentially applied to the scan electrodes Y and at the same time a positive data pulse DP is applied to the address electrodes at the address period AP. The wall voltage generated at the reset period RP is added to the voltage difference between the scan pulse SCNP and data pulse DP, and thereby an address discharge occurs in the cells applied with the data pulse DP. Wall charges are generated in the cells selected by the address discharge.

On the other hand, a positive bias voltage Vzb is applied to the sustain electrodes Z during the set down period SD and address period AP.

A sustain pulse Sus is alternately applied to the scan electrodes Y and the sustain electrodes Z at the sustain period. At this time, the wall voltage in the cells is added to the sustain pulse SUSP in the cells selected by the address discharge, and thereby a sustain discharge, i.e. a display discharge to display images, occurs in the form of surface discharge between the scan electrodes Y and the sustain electrodes Z whenever the sustain pulse is applied to be added with the wall voltage in the cells. The above-mentioned procedure completes a cycle of driving a plasma display panel in one subfield.

As described above, a rising ramp-type set up pulse is simultaneously applied to all the scan electrodes during a reset period in the prior art. In the prior art, however, there has existed a problem in that circuit elements required to implement this ramp-type pulse cause the increase of manufacturing costs.

In the prior art, there has also existed a problem in that wall charges in the cells, where the occurrence of an address discharge is late in the scan order, can be lost due to the recombination between charges with the lapse of time from the occurrence of a set up discharge to the occurrence of an address discharge since all the set up pulses are simultaneously applied to all the scan electrodes but an address discharge occurs sequentially according to the scan order, and this can cause the address discharge to be unstable.

### SUMMARY

In one aspect, a plasma display apparatus comprises a plasma display panel comprising scan electrodes, and a scan driver comprising a set up pulse supplier forming a current loop connecting a resistor and capacitors of the plasma display panel to the scan electrodes to thereby supply set up pulses to the scan electrodes.

The scan driver may adjust point of time of application of the set up pulses according to the scan order to supply the set up pulses to the scan electrodes.

The set pulse supplier may comprise a set up integrated circuit unit comprising unit switching units as many as the number of the scan electrodes to control points of time of application of the set up pulses with respect to each scan electrode; and a resistor connected between a set up voltage source and the set up integrated circuit unit to determine rising slopes of the set up pulses.

The unit switching units each may comprise two switching elements connected in series with each other, and a common connection terminal of two switching elements is connected to the scan electrode of the panel capacitor.

The unit switching units may adjust ON/OFF time of the switching elements to thereby adjust points of time of application of the set up pulses applied to the scan electrodes.

The points of time of application of the set up pulses may become late according to the scan order.

In another aspect, a plasma display apparatus comprises a plasma display panel comprising scan electrodes, and a scan driver adjusting points of time of application or application duration of set up pulses according to the scan order with respect to each scan electrode group to supply set up pulses to a plurality of scan electrode groups comprising two or more scan electrodes among the scan electrodes, and the scan driver comprises a set up pulse supplier forming a current loop connecting a resistor and capacitors of the plasma display panel to the scan electrode groups to thereby supply set up pulses to the scan electrode groups.

The set pulse supplier may comprise set up integrated circuit units comprising unit switching units as many as the number of the scan electrodes comprised in each scan electrode group to control points of time of application or application duration of the set up pulses with respect to each scan electrode group, the number of the set up integrated circuit unit corresponding to the number of the scan electrode groups.

The set up pulse supplier may comprise resistors connected between a set up voltage source and the set up integrated circuit unit to determine rising slopes of the set up pulses, the number of the resistors corresponding to the number of the scan electrode groups.

The unit switching units each may comprise two switching elements connected in series with each other, and a common connection terminal of two switching elements may be connected to the scan electrode of the panel capacitor.

The resistors may have the same resistance.

The unit switching units may adjust ON/OFF time of the switching elements to thereby adjust points of time of application of the set up pulses applied to the scan electrode groups.

The points of time of application of the set up pulses may become late according to the scan order.

The resistance of the resistors may increase according to the scan order.

The unit switching units may adjust ON/OFF time of the switching elements to thereby adjust points of time of application or application duration of the set up pulses applied to the scan electrode groups.

The points of time of application of the set up pulses may become late according to the scan order.

The application duration of the set up pulses may become long according to the scan order.

### BRIEF DESCRIPTION OF THE DRAWINGS

FIG. 1 is a view showing a subfield pattern of 8 bit default code for implementing 256 gray scale in a PDP;

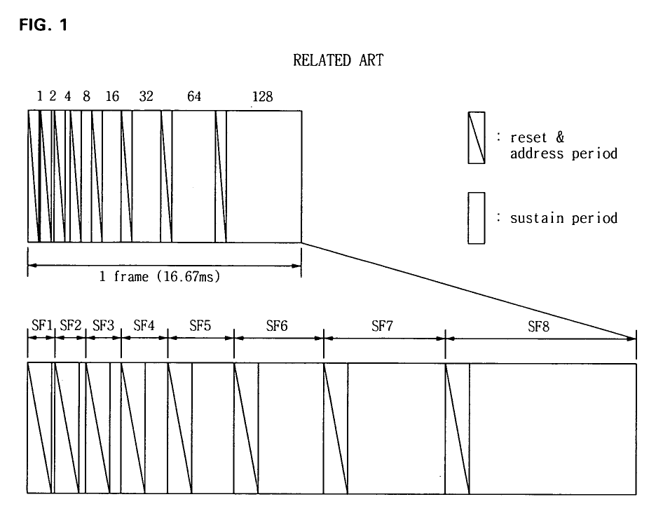

FIG. 2 is a view illustrating driving waveforms of a related art plasma display panel;

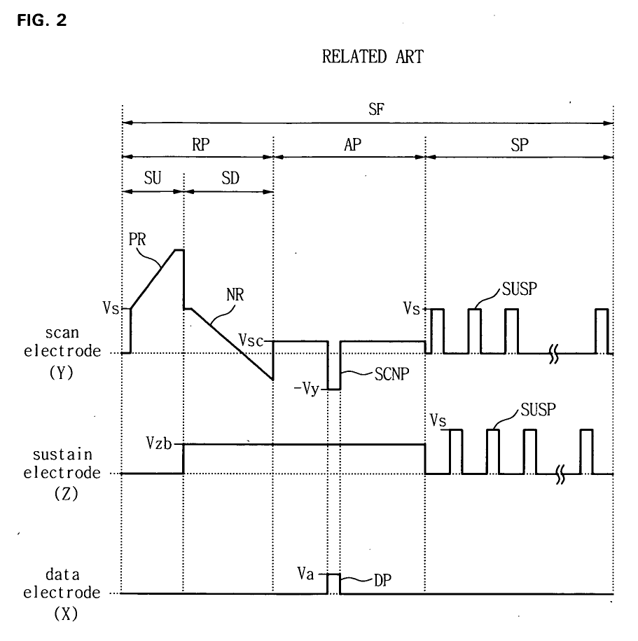

FIG. 3 is a view illustrating a plasma display apparatus according to a first embodiment of the present invention;

FIG. 4 is a view illustrating a set up pulse supplier comprised in a scan driver of the plasma display apparatus according to the first embodiment of the present invention;

FIG. 5 is a view illustrating driving waveforms of the plasma display apparatus according to the first embodiment of the present invention;

FIG. 6 is a view illustrating a set up pulse supplier comprised in a scan driver of a plasma display apparatus according to a second embodiment of the present invention;

FIG. 7 is a view illustrating driving waveforms of the plasma display apparatus according to the second embodiment of the present invention; and

FIG. 8 is a view illustrating varied driving waveforms of the plasma display apparatus according to the second embodiment of the present invention.

### DETAILED DESCRIPTION OF EMBODIMENTS

Several embodiments of the present invention will now be described with reference to accompanying drawings.

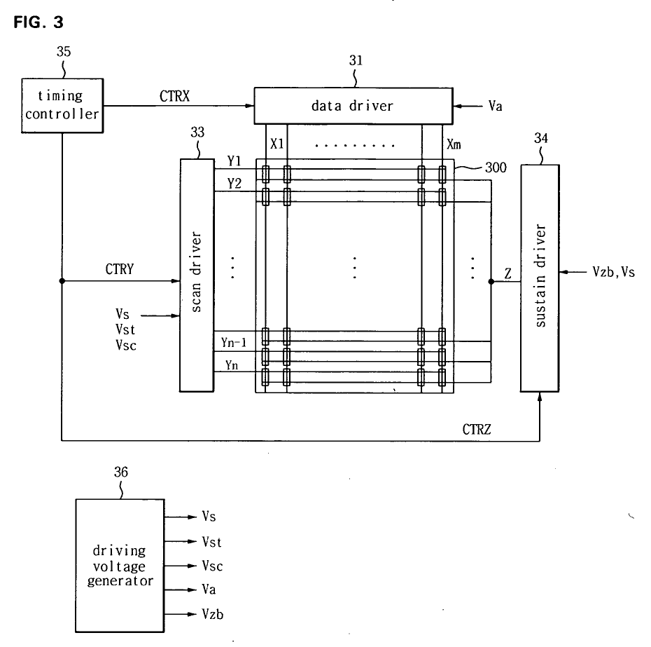

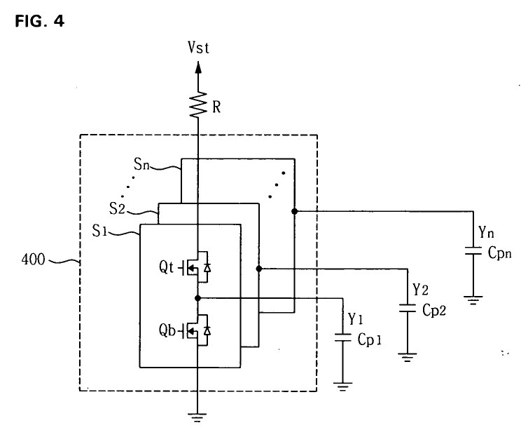

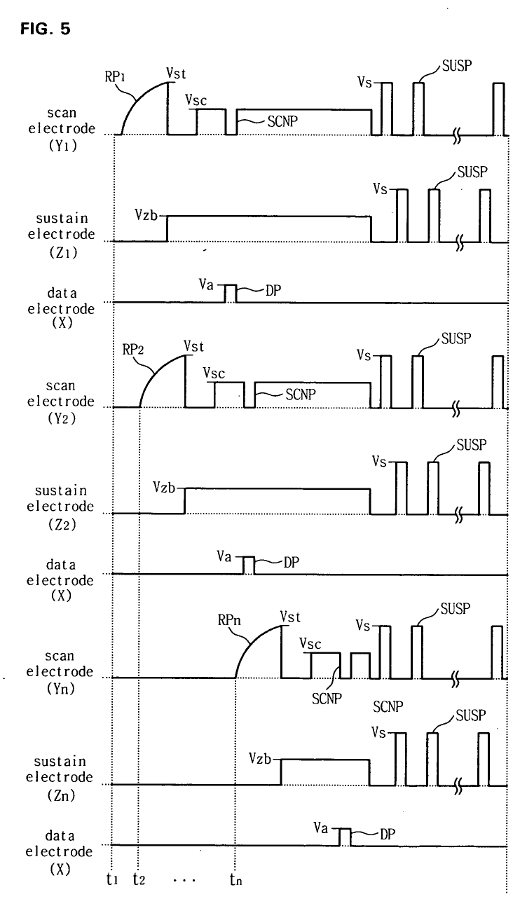

FIG. 3 is a view of illustrating a plasma display apparatus according to a first embodiment of the present invention, FIG. 4 is a view illustrating a set up pulse supplier comprised in a scan driver of a plasma display apparatus according to a second embodiment of the present invention, and FIG. 5 is a view illustrating driving waveforms of the plasma display apparatus according to the second embodiment of the present invention.

Referring to FIGS. 3 and 4, the plasma display apparatus according to the first embodiment of the present invention comprises a plasma display panel 300 comprising data electrodes X1 to Xm, scan electrodes Y1 to Yn, and a sustain electrode Z, a data driver 31 for supplying data to the data electrodes X1 to Xm, a scan driver 33 for driving the scan electrodes Y1 to Yn, and a sustain driver 34 for driving the sustain electrode Z, and a timing controller 35 for controlling each driver 31, 33, 34, and a driving voltage generator 36 for supplying driving voltages to each driver 31, 33, 34.

The plasma display panel 300 comprises a front panel (not shown) and a rear panel (not shown). The front panel and rear panel are attached to each other to be spaced by a constant interval, with a discharge space filled with inert gases between the front panel and rear panel. On the front panel there are formed the scan electrodes Y1 to Yn and the sustain electrode Z, each of the scan electrodes Y1 to Yn and the sustain electrode Z are paired. On the rear panel there are formed the data electrodes X1 to Xm to intersect the scan electrodes Y1 to Yn and sustain electrode Z.

The data driver 31 is supplied with data inverse-gamma corrected by an inverse gamma correction circuit, an error diffusion circuit and so on and then mapped according to a subfield pattern set up in advance by a subfield mapping circuit. The data driver 31 samples and latches the data under control of the timing controller 35 and then supplies the data to the data electrodes X1 to Xm.

The scan driver 33 adjusts the point of time of application of set up pulses according to the scan order and sequentially supplies the set up pulses to the scan electrodes Y1 to Yn under control of the timing controller 35 during a set up period.

The scan driver 33 comprises a set up pulse supplier for forming a current loop connecting a resistor R and panel capacitors Cp1 to Cpn to the scan electrodes Y1 to Yn to thereby supply the set up pulses. A panel capacitor defines capacitance between a scan electrode Y and a sustain electrode Z of the plasma display panel 300.

Referring to FIG. 4, the set up pulse supplier comprises a set up voltage source Vst, a set up integrated circuit unit 400, and a resistor R.

The set up voltage source Vst is a voltage source for supplying set up pulses to the scan electrodes Y1 to Yn.

The set up integrated circuit unit 400 comprises unit switching units S1 to Sn integrated as many as the number of the scan electrodes Y1 to Yn, and each of the unit switching units S1 to Sn controls point of time of application of the set up pulses applied to each scan electrode Y1 to Yn.

Each of the unit switching units S1 to Sn comprises two switching elements Qt, Qb connected in series with each other, a common connection terminal of two switching elements Qt, Qb is connected to the scan electrodes Y1 to Yn of the panel capacitors Cp1 to Cpn.

The resistor R is connected between the set up voltage source Vst and the set up integrated circuit unit 400 to determine the rising slope of the set up pulse.

Referring to FIG. 5, if an upper switch Qt of a first unit switching unit S1 of FIG. 4 is turned on at the time t1 to supply a set up pulse RP1 to a first scan electrode Y1, then a current loop connecting a set up voltage source Vst, a resistor R, the upper switch Qt of the first unit switching unit S1, a panel capacitor Cp1 formed by the first scan electrode Y1, and the set up voltage source Vst is formed to supply the first scan electrode Y1 with the set up pulse RP1 rising up with a time constant determined depending on the resistance of the resistor R and capacitance of the panel capacitor Cp1 at the time t1.

Subsequently, if an upper switch (not shown) of a second unit switching unit S2 of FIG. 4 is turned on at the time t2 to supply a set up pulse RP2 to a second scan electrode Y2, then a current loop connecting the set up voltage source Vst, the resistor R, the upper switch of the second unit switching unit S2, a panel capacitor Cp2 formed by the second scan electrode Y2, and the set up voltage source Vst is formed to supply the second scan electrode Y2 with the set up pulse RP2 rising up with a time constant determined depending on the resistance of the resistor R and capacitance of the panel capacitor Cp2 at the time t2.

A stable address discharge can be generated by adjusting the points of time of application of the set up pulses RP1 to RPn applied to the scan electrodes Y1 to Yn by the above-mentioned method.

In consideration of the loss of wall charges created during a period from the occurrence of a set up discharge to the occurrence of an address discharge, the points of time of application of the set up pulses RP1 to RPn are made to be late according to the scan order.

The scan driver 33 applies the scan electrodes Y1 to Yn with a scan reference voltage Vsc and a scan pulse SCNP falling from a scan reference voltage Vsc to ground in order to select a scan line during the address period after the set up pulses were supplied to the scan electrodes Y1 to Yn.

The scan driver 33 supplies the scan electrodes Y1 to Yn with a sustain pulse SUSP which enables a sustain discharge to occur in the cells selected at the address period during the sustain period.

The sustain driver 34 supplies a positive bias voltage Vzb to the sustain electrode Z during a period comprising the address period under control of the timing controller 35, and then the sustain driver 34 and the scan driver 33 take turns in supplying a sustain pulse SUSP to the sustain electrode Z during the sustain period

The timing controller 35 controls each driver 31, 33, 34 by receiving vertical/horizontal synchronization signals to generate timing control signals CTRX, CTRY, CTRZ required for each driver and supplying the timing control signals CTRX, CTRY, CTRZ to the corresponding drivers 31, 33, 34. The timing signal CTRX applied to the data driver 31 comprises sampling clocks for sampling data, latch control signals, and switch control signals for controlling ON/OFF time of the energy recovery circuit and driving switch elements. The timing signal CTRY applied to the data driver 33 comprises switch control signals for controlling ON/OFF time of the energy recovery circuit and driving switch elements in the scan driver 33. The timing signal CTRZ applied to the data driver 34 comprises switch control signals for controlling ON/OFF time of the energy recovery circuit and driving switch elements in the sustain driver 34.

The driving voltage generator 36 generates various driving voltages required for each driver 31, 33, 34 comprising a sustain voltage Vs, a set up voltage Vst, a scan reference voltage Vsc, a data voltage Va, and so on. The drive voltages can be varied depending on the composition of discharge gases or the construction of discharge cell.

As described above, the plasma display apparatus according to the first embodiment of the present invention can save manufacturing costs by simplifying the circuit for implementing set up pulses and stabilize an address discharge by enhancing waveforms of the set up pulses and points of time of application of the set up pulses to thereby stabilize the entire driving procedures.

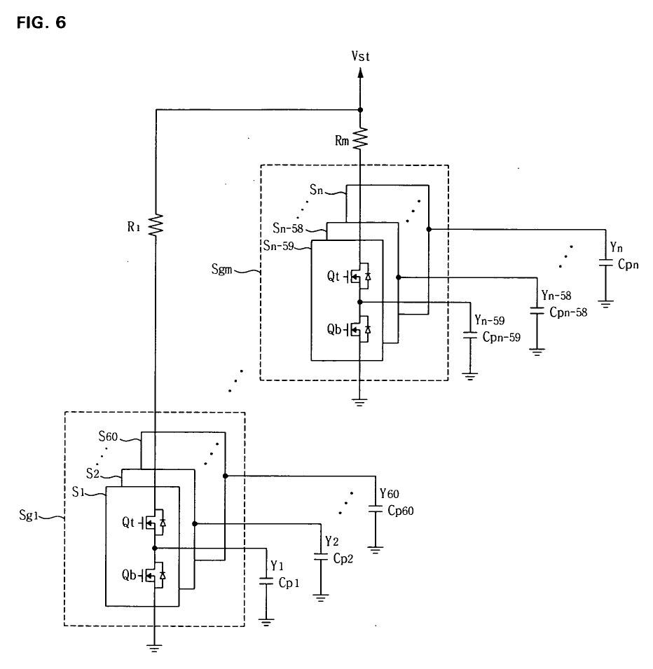

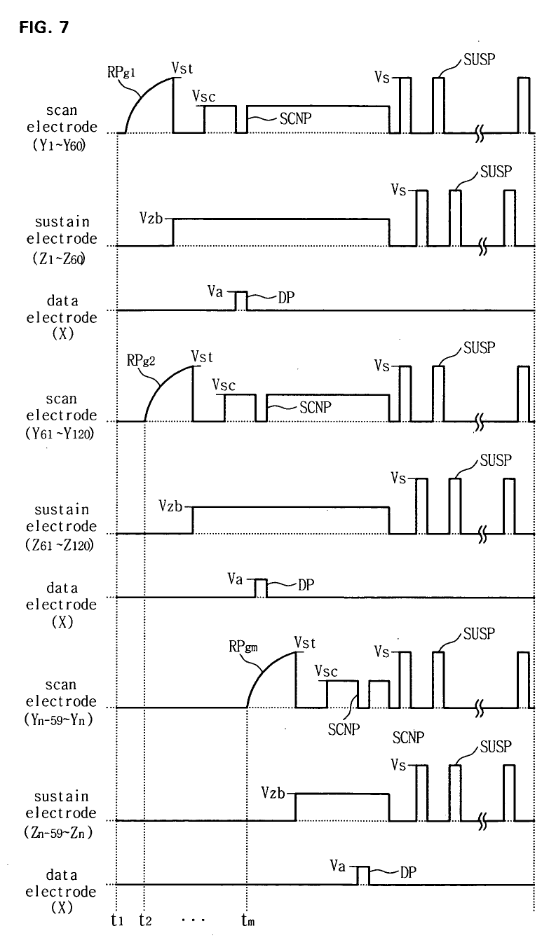

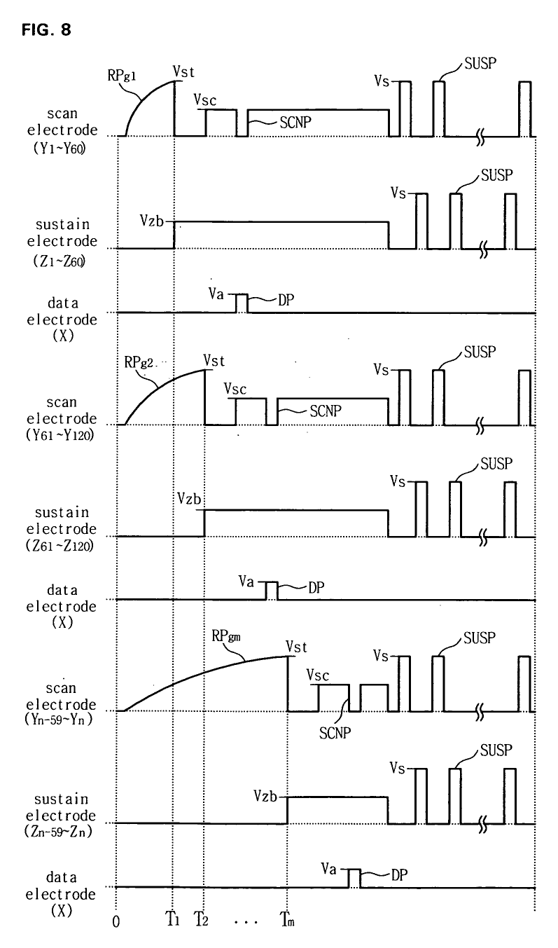

FIG. 6 is a view illustrating a set up pulse supplier comprised in a scan driver of a plasma display apparatus according to a second embodiment of the present invention, ?FIG. 7 is a view illustrating driving waveforms of the plasma display apparatus according to the second embodiment of the present invention, and FIG. 8 is a view illustrating driving varied waveforms of the plasma display apparatus according to the second embodiment of the present invention.

Hereinafter, the descriptions for components of the second embodiment corresponding to components of the first embodiment of the present invention are replaced by those of the first embodiment of the present invention. And, for the convenience of description, the plasma display apparatus according to the second embodiment of the present invention will be described with reference to FIG. 3.

Referring to FIGS. 3 and 6, the plasma display apparatus according to the second embodiment of the present invention comprises a plasma display panel 300 comprising data electrodes X1 to Xm, scan electrodes Y1 to Yn, and a sustain electrode Z, a data driver 31 for supplying data to the data electrodes X1 to Xm, a scan driver 33 for driving the scan electrodes Y1 to Yn, and a sustain driver 34 for driving the sustain electrode Z, and a timing controller 35 for controlling each driver 31, 33, 34, and a driving voltage generator 36 for supplying driving voltages to each driver 31, 33, 34.

The scan driver 33 adjusts the point of time of application of set up pulses according to the scan order and sequentially supplies the set up pulses to a plurality of scan electrode group comprising two or more scan electrodes among the scan electrodes Y1 to Yn under control of the timing controller 35 during a set up period. The scan driver 33 comprises a set up pulse supplier for forming a current loop connecting resistors R1 to Rm and panel capacitors Cp1 to Cpn to the scan electrode groups to thereby supply the set up pulses. A panel capacitor defines capacitance between a scan electrode Y and a sustain electrode Z of the plasma display panel 300.

Referring to FIG. 6, the set up pulse supplier comprises a set up voltage source Vst, set up integrated circuit units Sg1 to Sgm, and resistors R1 to Rm.

The set up voltage source Vst is a voltage source for supplying set up pulses to the scan electrode groups.

The set up integrated circuit units Sg1 to Sgm are provided as many as the number of the scan electrode groups, and each set up integrated circuit is integrated with unit switching units as many as the number corresponding to the number of the scan electrodes comprised in each scan electrode group. On the other hand, the number of the scan electrodes comprised in each scan electrode group can be varied depending on the number of output pins of the set up integrated units corresponding to each scan electrode group, and the number of the scan electrodes comprised in each scan electrode group can be adjusted variously by combining the set up integrated circuit units having the different number of output pins.

For example, assuming that the number of output pins of a first set up integrated circuit unit Sg1 controlling to supply set up pulses to the scan electrode group corresponding to the first order in the scan order is 60, the first set up integrated circuit unit Sg1 controlling the point of time of set up pulses supplied to a scan electrode group comprising the first to sixtieth scan electrodes Y1 to Y60 would be integrated with unit switching units S1 to S60 for supplying set up pulses to each of the first scan electrode Y1 to the sixtieth scan electrode Y60.

Each of the unit switching units S1 to Sn comprises two switching elements Qt, Qb connected in series with each other, a common connection terminal of two switching elements Qt, Qb is connected to the scan electrodes Y1 to Yn of the panel capacitors Cp1 to Cpn.

The resistors R1 to Rm are provided as many as the number of the scan electrode groups and connected between the set up voltage source Vst and set up integrated circuit units Sg1 to Sgm to thereby determine the rising slope of the set up pulse.

Referring to FIG. 7, if upper switches Qt of all the unit switching units S1 to S60 integrated at the first set up integrated circuit unit Sg1 of FIG. 6 are simultaneously turned on at the time t1 to supply a set up pulse RPg1 to the first scan electrode group Y1 to Y60, then a current loop connecting a set up voltage source Vst, a first resistor R1, the upper switches Qt of all the unit switching units S1 to S60 integrated at the first set up integrated circuit unit Sg1, panel capacitors Cp1 to Cp60 formed by all the scan electrodes Y1 to Y60 comprised in the first scan electrode group Y1 to Y60, and the set up voltage source Vst is formed to supply all the scan electrodes Y1 to Y60 comprised in the first scan electrode group Y1 to Y60 with the set up pulse RPg1 rising up with a time constant determined depending on the resistance of the first resistor R and capacitance of the panel capacitors Cp1 to Cp60 at the time t1.

A stable address discharge can be generated by adjusting the points t1 to tm of time of application of the set up pulses RPg1 to RPgm sequentially applied to the scan electrode groups by the above-mentioned method.

The resistors R1 to Rm are set to have the same resistance. This enables time constants of all the set up pulses RPg1 to RPgm to have the same values and enables only the point of time of each set up pulse to be different, and thus subsequent address discharges can be prepared.

In consideration of the loss of wall charges created during a period from the occurrence of a set up discharge to the occurrence of an address discharge, the points t1 to tm of time of application of the set up pulses RPg1 to RPgm are made to be late according to the scan order.

As described above, the plasma display apparatus according to the second embodiment of the present invention can save manufacturing costs by simplifying the circuit for implementing set up pulses and stabilize an address discharge by enhancing waveforms of the set up pulses and points of time of application of the set up pulses with respect to each scan electrode group to thereby stabilize the entire driving procedures.

Referring to FIG. 8, a varied embodiment of the second embodiment employs a way to adjust the points of time of application of the set up pulses RPg1 to RPgm applied to the scan electrode groups.

The varied embodiment of the second embodiment are implemented by the same driving principle as that of the second embodiment, the detailed descriptions will be replaced by the descriptions for the second embodiment.

However, the varied embodiment of the second embodiment makes a difference from the second embodiment in that while the points of time of application of the set up pulses RPg1 to RPgm applied to the scan electrode groups are set up equally, the application duration of the set up pulses RPg1 to RPgm is adjusted long depending on the scan order and the rising slopes of the set up pulses RPg1 to RPgm are set to be gradually gentle according to the scan order by making the resistance of the resistors R1 to Rm of FIG. 6 increase according to the scan order(i.e. R1<R2< . . . <Rm) to thereby increase the time constants of the set up pulses RPg1 to RPgm. This makes it possible to efficiently cope with the loss of wall charges created during a period from the occurrence of a set up discharge to the occurrence of an address discharge and ensure a stable address discharge.

As mentioned above, the present invention can save manufacturing costs of a plasma display apparatus by simplifying a circuit for implementing set up pulses.

In addition, the present invention can stabilize an address discharge by enhancing waveforms of the set up pulses and points of time of application of the set up pulses to thereby stabilize the entire driving procedures.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display apparatus comprising:
a plasma display panel comprising scan electrodes; and
a scan driver comprising a set up pulse supplier forming a current loop connecting a resistor and capacitors of the plasma display panel to the scan electrodes to thereby supply set up pulses to the scan electrodes.

2. The plasma display apparatus of claim 1, wherein the scan driver adjusts point of time of application of the set up pulses according to the scan order to supply the set up pulses to the scan electrodes.

3. The plasma display apparatus of claim 2, wherein the set pulse supplier comprises a set up integrated circuit unit comprising unit switching units as many as the number of the scan electrodes to control points of time of application of the set up pulses with respect to each scan electrode; and
a resistor connected between a set up voltage source and the set up integrated circuit unit to determine rising slopes of the set up pulses.

4. The plasma display apparatus of claim 3, wherein the unit switching units each comprise two switching elements connected in series with each other, and
a common connection terminal of two switching elements is connected to the scan electrode of the panel capacitor.

5. The plasma display apparatus of claim 4, wherein the unit switching units adjust ON/OFF time of the switching elements to thereby adjust points of time of application of the set up pulses applied to the scan electrodes.

6. The plasma display apparatus of claim 5, wherein the points of time of application of the set up pulses become late according to the scan order.

7. A plasma display apparatus comprising:
a plasma display panel comprising scan electrodes; and
a scan driver adjusts points of time of application or application duration of set up pulses according to the scan order with respect to each scan electrode group to supply set up pulses to a plurality of scan electrode groups comprising two or more scan electrodes among the scan electrodes, and
wherein the scan driver comprises a set up pulse supplier forming a current loop connecting a resistor and capacitors of the plasma display panel to the scan electrode groups to thereby supply set up pulses to the scan electrode groups.

8. The plasma display apparatus of claim 7, wherein the set pulse supplier comprises set up integrated circuit units comprising unit switching units as many as the number of the scan electrodes comprised in each scan electrode group to control points of time of application or application duration of the set up pulses with respect to each scan electrode group, the number of the set up integrated circuit unit corresponding to the number of the scan electrode groups.

9. The plasma display apparatus of claim 7, wherein the set up pulse supplier comprises resistors connected between a set up voltage source and the set up integrated circuit unit to determine rising slopes of the set up pulses, the number of the resistors corresponding to the number of the scan electrode groups.

10. The plasma display apparatus of claim 8, wherein the unit switching units each comprise two switching elements connected in series with each other, and
a common connection terminal of two switching elements is connected to the scan electrode of the panel capacitor.

11. The plasma display apparatus of claim 9, wherein the resistors have the same resistance.

12. The plasma display apparatus of claim 10, wherein the unit switching units adjust ON/OFF time of the switching elements to thereby adjust points of time of application of the set up pulses applied to the scan electrode groups.

13. The plasma display apparatus of claim 12, wherein the points of time of application of the set up pulses become late according to the scan order.

14. The plasma display apparatus of claim 9, wherein the resistance of the resistors increases according to the scan order.

15. The plasma display apparatus of claim 13, wherein the unit switching units adjust ON/OFF time of the switching elements to thereby adjust points of time of application or application duration of the set up pulses applied to the scan electrode groups.

16. The plasma display apparatus of claim 15, wherein the points of time of application of the set up pulses become late according to the scan order.

17. The plasma display apparatus of claim 16, wherein the application duration of the set up pulses become long according to the scan order.

18. The plasma display apparatus of claim 15, wherein the application duration of the set up pulses become long according to the scan order.
